(19) United States
(12) Patent Application Publication
(10) Pub. No.: US 2025/0001831 A1
(43) Pub. Date: Jan. 2, 2025

(54) METHOD FOR SETTING AN AIR CONDITIONER

(71) Applicant: MAHLE INTERNATIONAL GMBH, Stuttgart (DE)

(72) Inventors: Marcel GÜNTER, Stuttgart (DE); Marco ROTH, Stuttgart (DE); Kristian HAASE, Leinfelden-Echterdingen (DE); Lars LUDWIG, Altbach (DE)

(21) Appl. No.: 18/753,098

(22) Filed: Jun. 25, 2024

(30) Foreign Application Priority Data
Jun. 27, 2023 (DE) 102023206036.1

(51) Int. Cl. B60H 1/00

(52) U.S. Cl. CPC B60H 1/0073; B60H 1/00742

(57) ABSTRACT

A method for individualized setting of an air conditioner in a vehicle for a user using a control architecture is provided. Data for the air conditioner are acquired and an individualized comfort model is trained therewith. Settings for the air conditioner are predicted based on the comfort model. The data comprise physiological user data for the user that are acquired with an evaluation system.

A control architecture for executing the method is also provided.

### CROSS-REFERENCE TO RELATED APPLICATIONS

This application claims priority to German Patent Application No. 10 2023 206 036.1, filed Jun. 27, 2023, the entirety of which is hereby incorporated by reference herein.

The invention relates to a method for individualized setting of an air conditioner in a vehicle using a control architecture according to the preamble of claim 1. The invention also relates to the control architecture for executing the method.

An air conditioner user can set the temperature by changing numerous parameters based on the user's thermal perceptions. The air conditioner can be set by a climate control system based on an engine performance map, thus simplifying use of the air conditioner. The thermal perceptions of an individual user may be very specific, however. Conventional performance map-based climate controls are configured for “average” people, and cannot be adjusted to individual users. If the user does not feel comfortable with performance map-based climate control, the air conditioner has to be adjusted manually.

AI-supported comfort models (AI: artificial intelligence) that can be adjusted to individual preferences have also been proposed. With these, the user's settings for the air conditioner are correlated with context data, e.g. exterior temperature or interior temperature, and used for training the comfort model. The trained comfort model can then predict the optimal settings of the air conditioner for individual users at predefined times from the context data. Unfortunately, the user's thermal comfort perceptions are not only dependent on thermal context data, but also on the user's physiological state.

Comparable solutions have been disclosed in DE 11 2013 003 595 T5, DE 11 2019 000 315 T5, and DE 10 2014 102 827 A1.

The object of the invention is to therefore create an improved, or at least alternative, method with which the above disadvantages are resolved. It is also the object of the invention to create a corresponding control architecture for executing the method.

This is achieved according to the invention by the subject matter of the independent claims. Advantageous embodiments are the subject matter of the dependent claims.

The present invention is based on the general idea of detecting physiological states of a user with minimal demands on additional sensors, and training an AI-based comfort model on the basis thereof.

The method is intended for individualized setting of an air conditioner in a vehicle for a user using a control architecture. Setting data for the air conditioner are acquired by the control architecture, and an individualized comfort model for the air conditioner is trained in an AI unit therewith. The setting data in the context of the present invention are understood to be those data or values that are relevant when setting the air conditioner and/or can be used in the comfort model when predicting the individualized settings. Individualized settings for the air conditioner are then predicted based on the trained comfort model. These setting data include physiological user data acquired with an evaluation system in the control architecture that are sent to the AI unit.

The setting data for the air conditioner can be sent to a cloud storage, and used to train the individualized comfort model. The cloud is a network that provides computer resources such as servers, and/or data storage, and/or applications. The individualized comfort model can be created in this manner, which then predicts the individualized settings for the air conditioner based on the setting data for the air conditioner. It is understood that numerous comfort models for numerous users can also be trained in the cloud.

The evaluation system can contain a camera system in the interior of the vehicle, with which images are recorded from which the physiological user data are acquired. The camera system can contain a camera and/or infrared camera, and the image data can be acquired with the camera and/or the infrared camera. This is a particularly simple means of acquiring physiological user data. The physiological user data can be determined from the image data using at least one AI-based method and/or an extraction process. These physiological user data can include skin temperature and/or heart rate, and/or respiratory rate, and/or clothing state, and/or positioning of extremities, and/or age, and/or gender, and/or size, and/or weight, and/or emotional state, and/or wakefulness. It is clear that this list can be expanded.

The evaluation system can include a sensor system in the interior of the vehicle. Sensor data can be acquired with the sensor system, and physiological user data can be acquired from the sensor data. User data such as skin temperature, and/or heart rate, and/or respiratory rate, and/or weight, can be determined from the sensor data.

The setting data for the air conditioner can also include context data for the vehicle. This context data can include the interior temperature, and/or exterior temperature, and/or humidity, and/or the position of the sun, and/or light intensity or brightness, and/or air pressure. This context data can be used for training the comfort model in the AI unit.

The setting data for the air conditioner can also include user input data. This user input data can include temperature settings and/or fan settings, and/or heated seat settings, and/or heated surface settings, and/or heating and/or cooling settings that are set manually by the user. The user input data can be used to train the comfort model in the AI unit.

The invention also relates to a control architecture for executing the method described above. The control architecture is designed to execute the method. In detail, the control architecture is designed to acquire the setting data for the air conditioner, train the individualized comfort model for the air conditioner with the acquired data in the AI unit, predict individualized settings for the air conditioner based on the trained comfort model, and determine the physiological user data in the setting data for the user with the evaluation system and send the physiological user data to the AI unit. It is understood that the control architecture contains the necessary hardware and software for executing the method. To avoid repetition, reference is made here to the above explanations.

Important features and advantages of the invention can be derived from the dependent claims, the drawings, and the descriptions of the drawings.

It is understood that the features specified above and explained below can be used not only in the given combinations, but also in other combinations or in and of themselves, without abandoning the framework of the present invention.

Preferred exemplary embodiments of the invention are shown in the drawings, and shall be explained below in greater detail.

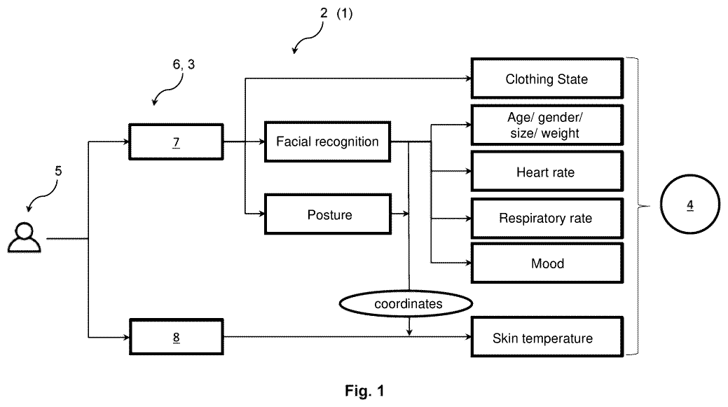

The sole FIG. 1 shows a schematic illustration of a data structure in a method 1, or control architecture 2, according to the invention. This control architecture 2 contains an evaluation system 3 that acquires physiological user data 4 for the user 5. The evaluation system 3 contains a camera system 6 with both a camera 7 and an infrared camera 8.

The camera 7 records image data that can be used to determine physiological user data 4 such as the state of the user's clothing and the user's posture. Furthermore, physiological user data 4 such as age, gender, size, weight, and mood of the user 5 are determined through facial recognition applied to the image data.

The infrared camera 8 records image data that are used for determining physiological user data 4 such as skin temperature. The coordinates obtained with the image data from the camera 7 can also be used for determining skin temperature.

The physiological user data 4 can be acquired from the image data using at least one AI-based method and/or an extraction process. The physiological user data 4 are then used as scaling values for training a comfort model in an AI unit.

The specification can be readily understood with reference to the following Representative Paragraphs:

Representative Paragraph 1. A method (1) for individualized setting of an air conditioner in a vehicle for a user (5), wherein, by means of a control architecture (2):
setting data for the air conditioner are acquired,
an individualized comfort model for the air conditioner is trained in an AI unit with the acquired data,
individualized settings for the air conditioner are predicted on the basis of the trained comfort model,
characterized in that the setting data contain physiological user data (4) for the user (5), wherein the physiological user data (4) are obtained using an evaluation system (3) in the control architecture (2) and sent to the AI unit.

Representative Paragraph 2. The method according to Representative Paragraph 1, characterized in that the evaluation system (3) contains a camera system (6) in the interior of the vehicle with which image data are acquired, and the physiological user data (4) are determined from the image data.

Representative Paragraph 3. The method according to Representative Paragraph 2, characterized in that the physiological user data (4) are obtained from the image data using at least one AI-based method and/or an extraction process.

Representative Paragraph 4. The method according to Representative Paragraph 2 or 3, characterized in that the camera system (6) contains a camera (7) and/or an infrared camera (8), wherein the image data for acquiring the physiological user data (4) are acquired with the camera (7) and/or the infrared camera (8).

Representative Paragraph 5. The method according to any of the Representative Paragraphs 2 to 4, characterized in that the physiological user data (4) for the user (5) are determined from the image data, e.g. skin temperature, and/or heart rate, and/or respiratory rate, and/or age, and/or gender, and/or size, and/or weight, and/or emotional state, and/or wakefulness.

Representative Paragraph 6. The method according to any of the preceding Representative Paragraphs, characterized in that the evaluation system (3) contains a sensor system in the interior of the vehicle, wherein sensor data are acquired with the sensor system, and the physiological user data (4) for the user (5) are determined from the sensor data.

Representative Paragraph 7. The method according to Representative Paragraph 6, characterized in that the physiological user data (4) for the user (5) are obtained from the sensor data, e.g. skin temperature, and/or heart rate, and/or respiratory rate, and/or weight.

Representative Paragraph 8. The method according to any of the preceding Representative Paragraphs, characterized in that
the setting data for the air conditioner contain context data for the vehicle, wherein the context data are acquired with a sensor system in the control architecture (2), and
the context data include the interior temperature, and/or exterior temperature, and/or humidity, and/or position of the sun, and/or light intensity, and/or air pressure.

Representative Paragraph 9. The method according to any of the preceding Representative Paragraphs, characterized in that
the setting data for the air conditioner include user input data, wherein the user input data are entered by the user (5), and
the user input data include temperature settings, and/or fan settings, and/or heated seat settings, and/or heated surface settings, and/or heating and/or cooling settings.

Representative Paragraph 10. A control architecture (2) for executing the method (1) according to any of the preceding Representative Paragraphs, wherein the control architecture (2) is designed to:
acquire the setting data for the air conditioner,
train the individualized comfort model for the air conditioner with the acquired data in the AI unit,
predict the individualized settings for the air conditioner based on the trained comfort model, and
determine the physiological user data (4) for the setting data for the user (5) using the evaluation system (3) and send the physiological user data (4) to the AI unit.

1. A method for individualized setting of an air conditioner in a vehicle for a user, wherein, by means of a control architecture:
setting data for the air conditioner are acquired,
an individualized comfort model for the air conditioner is trained in an AI unit with the acquired data,
individualized settings for the air conditioner are predicted on the basis of the trained comfort model,
wherein the setting data contain physiological user data for the user, wherein the physiological user data are obtained using an evaluation system in the control architecture and sent to the AI unit.

2. The method according to claim 1, wherein the evaluation system contains a camera system in the interior of the vehicle with which image data are acquired, and the physiological user data are determined from the image data.

3. The method according to claim 2, wherein the physiological user data are obtained from the image data using at least one AI-based method and/or an extraction process.

4. The method according to claim 2, wherein the camera system contains a camera and/or an infrared camera, wherein the image data for acquiring the physiological user data are acquired with the camera and/or the infrared camera.

5. The method according to claim 2, wherein the physiological user data for the user are determined from the image data, e.g. skin temperature, and/or heart rate, and/or respiratory rate, and/or age, and/or gender, and/or size, and/or weight, and/or emotional state, and/or wakefulness.

6. The method according to claim 1, wherein the evaluation system contains a sensor system in the interior of the vehicle, wherein sensor data are acquired with the sensor system, and the physiological user data for the user are determined from the sensor data.

7. The method according to claim 6, wherein the physiological user data for the user are obtained from the sensor data, e.g. skin temperature, and/or heart rate, and/or respiratory rate, and/or weight.

8. The method according to claim 1, wherein
the setting data for the air conditioner contain context data for the vehicle, wherein the context data are acquired with a sensor system in the control architecture, and
the context data include the interior temperature, and/or exterior temperature, and/or humidity, and/or position of the sun, and/or light intensity, and/or air pressure.

9. The method according to claim 1, wherein
the setting data for the air conditioner include user input data, wherein the user input data are entered by the user, and
the user input data include temperature settings, and/or fan settings, and/or heated seat settings, and/or heated surface settings, and/or heating and/or cooling settings.

10. A control architecture for executing the method according to claim 1, wherein the control architecture is designed to:
acquire the setting data for the air conditioner,
train the individualized comfort model for the air conditioner with the acquired data in the AI unit,
predict the individualized settings for the air conditioner based on the trained comfort model, and
determine the physiological user data for the setting data for the user using the evaluation system and send the physiological user data to the AI unit.
